(19) United States
(12) Patent Application Publication
(10) Pub. No.: US 2020/0053055 A1
(43) Pub. Date: Feb. 13, 2020

(54) DEVICES AND METHODS FOR REQUESTING AND/OR SUPPLYING INFORMATION

(71) Applicant: CONNECT2ME PTE LTD, SINGAPORE (SG)

(72) Inventors: CHING YAU KANG, SINGAPORE (SG); XIANGDONG CHEN, SINGAPORE (SG)

(21) Appl. No.: 16/486,319

(22) PCT Filed: Aug. 24, 2017
(86) PCT No.: PCT/SG2017/050417

§ 371 Date: Aug. 15, 2019

(30) Foreign Application Priority Data
Feb. 17, 2017 (SG) 10201701300W
Jun. 6, 2017 (SG) 10201704619V
Aug. 24, 2017 (SG) PCT/SG2017/050417

(51) Int. Cl. H04L 29/06; H04W 4/80; H04W 84/12

(52) U.S. Cl. CPC H04L 63/0428; H04L 2209/601; H04W 84/12; H04W 4/80

(57) ABSTRACT

According to embodiments of the present invention, devices and methods for requesting information from a target unit and/or for supplying information to a requesting unit are provided. The devices may include one or more modules such as a transmitting module, a processing module, a processor and a memory. A data stream including a request for information may be broadcast. A return data signal may be broadcast including an identifier information based on at least a portion of the data stream, and information corresponding to the request. According to further embodiments of the present invention, there may also be provided applications adapted to be installed on a device, and computer programs and computer program products.

### CROSS-REFERENCE TO RELATED APPLICATION

This application claims the benefit of priority of Singapore patent application Nos. 10201701300W, filed 17 Feb. 2017, and 10201704619V, filed 6 Jun. 2017, the contents being hereby incorporated by reference in their entirety for all purposes.

### TECHNICAL FIELD

Various embodiments relate to devices for requesting information from a target unit and/or for supplying information to a requesting unit, methods for requesting information from a target unit and/or for supplying information to a requesting unit, applications therefor, computer programs therefor, and computer program products therefor.

### BACKGROUND

When one device sends a data or information signal to another device, the receiving device determines whether the signal is intended for it, and, if so, the receiving device then processes the signal. However, with numerous different devices transmitting multiple signals over the air, the receiving device faces challenges in filtering out the specific signal intended for it out of the numerous signals present in the air.

### SUMMARY

The invention is defined in the independent claims. Further embodiments of the invention are defined in the dependent claims.

According to an embodiment, a device for requesting information from a target unit is provided. The device may include a transmitting module configured to broadcast a data stream including a request for the target unit, and a processing module configured to retrieve, from a return data signal by the target unit including an identifier information based on at least a portion of the data stream, information corresponding to the request.

According to an embodiment, a device for requesting information from a target unit is provided. The device may include a processor, and a memory coupled to the processor, the memory having stored therein instructions, which when executed by the processor, cause the processor to broadcast a data stream including a request for the target unit, and retrieve, from a return data signal by the target unit including an identifier information based on at least a portion of the data stream, information corresponding to the request.

According to an embodiment, a device for supplying information to a requesting unit is provided. The device may include a processing module configured to broadcast, in response to a request included in a data stream received from the requesting unit, a return data signal including an identifier information based on at least a portion of the data stream, and information corresponding to the request.

According to an embodiment, a device for supplying information to a requesting unit is provided. The device may include a processor, and a memory coupled to the processor, the memory having stored therein instructions, which when executed by the processor, cause the processor to broadcast, in response to a request included in a data stream received from the requesting unit, a return data signal including an identifier information based on at least a portion of the data stream, and the information corresponding to the request.

According to an embodiment, a device is provided. The device may include a transmitting module, and a processing module, wherein, in a first mode of operation of the device, the transmitting module is configured to broadcast a data stream including a request for a target unit, and the processing module is configured to retrieve, from a return data signal by the target unit including an identifier information based on at least a portion of the data stream, information corresponding to the request, and wherein, in a second mode of operation of the device, the processing module is configured, in response to a request comprised in a data stream received from a requesting unit, to broadcast a return data signal including an identifier information based on at least a portion of the data stream, and information corresponding to the request.

According to an embodiment, a device is provided. The device may include a processor, and a memory coupled to the processor, the memory having stored therein instructions, which when executed by the processor, cause the processor, in a first mode of operation of the device, to broadcast a data stream including a request for the target unit, and to retrieve, from a return data signal by the target unit including an identifier information based on at least a portion of the data stream, information corresponding to the request, and, in a second mode of operation of the device, to broadcast, in response to a request comprised in a data stream received from a requesting unit, a return data signal including an identifier information based on at least a portion of the data stream, and information corresponding to the request.

According to an embodiment, a method for requesting information from a target unit is provided. The method may include broadcasting a data stream including a request for the target unit, and retrieving, from a return data signal by the target unit including an identifier information based on at least a portion of the data stream, information corresponding to the request.

According to an embodiment, a method for supplying information to a requesting unit is provided. The method may include broadcasting, in response to a request for information included in a data stream received from the requesting unit, a return data signal including an identifier information based on at least a portion of the data stream, and the information corresponding to the request.

According to an embodiment, a method for a device is provided. The method may include, in a first mode of operation of the device, broadcasting a data stream including a request for a target unit, and retrieving, from a return data signal by the target unit including an identifier information based on at least a portion of the data stream, information corresponding to the request, and, in a second mode of operation of the device, broadcasting, in response to a request for information included in a data stream received from a requesting unit, a return data signal including an identifier information based on at least a portion of the data stream, and the information corresponding to the request.

According to an embodiment, an application adapted to be installed on a device is provided. The application may include processor-executable instructions for execution on the device to carry out a method as described herein for requesting information from a target unit.

According to an embodiment, an application adapted to be installed on a device is provided. The application may include processor-executable instructions for execution on the device to carry out a method as described herein for supplying information to a requesting unit.

According to an embodiment, an application adapted to be installed on a device is provided. The application may include processor-executable instructions for execution on the device, to carry out, in a first mode of operation, a method as described herein for requesting information from a target unit, and, to carry out, in a second mode of operation, a method as described herein for supplying information to a requesting unit.

According to an embodiment, a computer program or a computer program product is provided. The computer program or a computer program product may include instructions which, when executed by a computing device, cause the computing device to carry out a method as described herein for requesting information from a target unit.

According to an embodiment, a computer program or a computer program product is provided. The computer program or a computer program product may include instructions which, when executed by a computing device, cause the computing device to carry out a method as described herein for supplying information to a requesting unit.

According to an embodiment, a computer program or a computer program product is provided. The computer program or a computer program product may include instructions which, when executed by a computing device, cause the computing device, to carry out, in a first mode of operation, a method as described herein for requesting information from a target unit, and, to carry out, in a second mode of operation, a method as described herein for supplying information to a requesting unit.

### BRIEF DESCRIPTION OF THE DRAWINGS

In the drawings, like reference characters generally refer to like parts throughout the different views. The drawings are not necessarily to scale, emphasis instead generally being placed upon illustrating the principles of the invention. In the following description, various embodiments of the invention are described with reference to the following drawings, in which:

FIG. 1A shows a schematic diagram for a device for requesting information from a target unit, according to various embodiments.

FIG. 1B shows a schematic diagram for a device for supplying information to a requesting unit, according to various embodiments.

FIG. 1C shows a schematic diagram for a device, according to various embodiments.

FIG. 1D shows a schematic diagram for a device, according to various embodiments.

FIG. 1E shows a flow chart illustrating a method for requesting information from a target unit, according to various embodiments.

FIG. 1F shows a method for supplying information to a requesting unit, according to various embodiments.

FIG. 1G shows a flow chart illustrating a method for a device, according to various embodiments.

FIG. 1H shows a schematic diagram for an application, according to various embodiments.

FIG. 1I shows a schematic diagram for a computer program or a computer program product, according to various embodiments.

FIG. 2 shows a schematic diagram illustrating flow charts for a method for information feedback, according to various embodiments.

FIG. 3 shows a schematic diagram illustrating a method for information feedback, according to various embodiments.

FIG. 4 shows a schematic diagram illustrating a method for information feedback, according to various embodiments.

FIG. 5 shows a schematic diagram illustrating flow charts for a method for generating a header, according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the methods or devices are analogously valid for the other methods or devices. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments.

Furthermore, additions and/or combinations and/or alternatives as described for a feature in the context of an embodiment may correspondingly be applicable to the same or similar feature in the other embodiments.

As used herein, the term “and/or” includes any and all combinations of one or more of the associated listed items.

As used herein, the phrase of the form of “at least one of A or B” may include A or B or both A and B. Correspondingly, the phrase of the form of “at least one of A or B or C”, or including further listed items, may include any and all combinations of one or more of the associated listed items.

Various embodiments may relate to information feedback, for example, status feedback. Various embodiments may use BLE (Bluetooth Low Energy) advertisement as both command and status feedback.

BLE advertisement is a broadcast technology whereby one device advertises and another device receives. The BLE advertisement broadcasts (on the transmitting side) a unique UUID (universally unique identifier) together with Major and Minor information (or Major and Minor portions or values) over the air, for example, using an iBeacon or Beacon protocol.

As a non-limiting example, the UUID (e.g., which may be a 16-byte string) may be employed to identify a large group of related beacons (so as to distinguish from other non-related beacons that may be associated with another entity), the Major information or value (e.g., which may be a 2-byte string) may be employed to identify or distinguish a smaller subset of beacons within the larger group (e.g., for all beacons within a specified geographical area), and the Minor information or value (e.g., which may be a 2-byte string) may be employed to identify or distinguish individual beacons within the smaller subset (e.g., for individual different beacons within the specified geographical area).

As for the receiver, it filters and only receives the specific UUID that is pre-configured (or predetermined) in the receiver. Thus, in order to maintain an Ad-Hoc RF (radio frequency) communication, the sender (or transmitter or transmitting device) may send to the receiver (or receiving device) a predetermined UUID so that when the information is being advertised back by the receiver to the sender, the sender may be able to identify that the information is from the targeted receiver that the sender had requested information from.

Various embodiments may provide one or more devices that may be RF (radio frequency) silent (e.g., in an RF silent mode) when there is no instruction (or command) or information request from the receiving device. By maintaining RF silence, the request for control and/or for information from the requesting device (e.g., mobile device) to the receiving device may be on an ad-hoc basis. Further, by maintaining RF silence, the presence of RF controllable devices may not be made known to any person. In other words, any person may be prevented from knowing that there may be RF controllable devices in the environment or ecosystem.

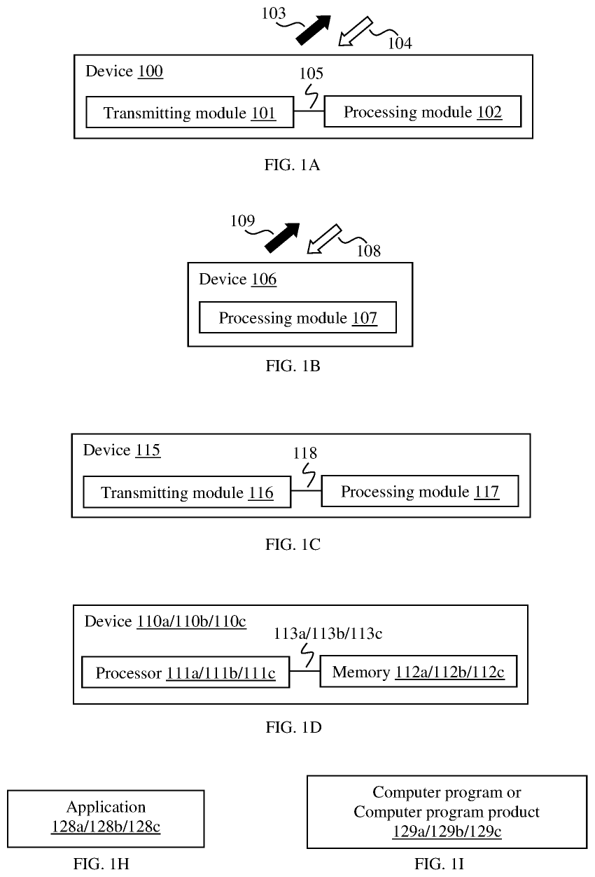

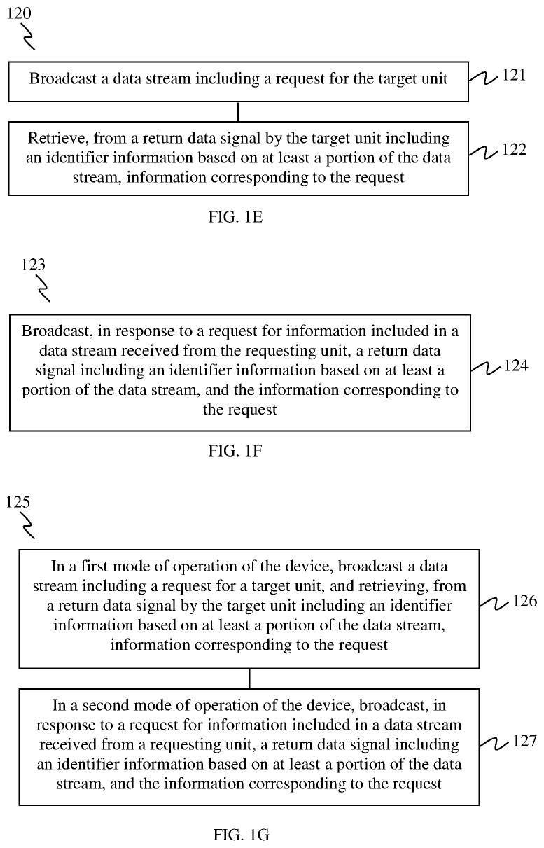

FIG. 1A shows a schematic diagram for a device 100 for requesting information from a target unit, according to various embodiments. The device 100 includes a transmitting module 101 configured to broadcast a data stream (represented by arrow 103) including a request for the target unit, and a processing module 102 configured to retrieve, from a return data signal (represented by arrow 104) by the target unit including an identifier information based on at least a portion of the data stream 103, information corresponding to the request. The transmitting module 101 and the processing module 102 may be coupled to one another (represented by the line 105), for example, physically coupled and/or electrically coupled.

In other words, a device 100 for requesting information from a target (receiving) unit may be provided. Accordingly, the device 100 may be an inquiring or requesting device capable of requesting information from a target unit. The device 100 may be used as part of a command and control system or communication. The device 100 may be a communication device. In various embodiments, the device 100 may be a phone (e.g., a smartphone), a tablet (computer), a server, etc.

The device 100 may include a transmitting module 101 configured to broadcast (e.g., wirelessly or via wireless communication) a data stream 103 having therein a request for information from the target unit, and a processing module 102 configured to retrieve (or extract), from a return data signal 104, which may be broadcast (e.g., wirelessly or via wireless communication) by the target unit, having therein an identifier information based on at least a portion of the data stream 103, the information corresponding to the request. The processing module 102 may include a receiving module configured to receive data broadcast over the air, including the return data signal 104. As the identifier information is formed using at least a portion of the data stream 103 broadcast by the (requesting) device 100, the identifier information may be a predetermined identifier information by the (requesting) device 100.

In the context of various embodiments, the term “identifier information” may refer to an identifier (or identifying) code or number. The identifier information may act as an identification or verification to the processing module 102 that the return data signal 104 is intended for the device 100. The identifier information based on at least a portion of the data stream 103 may be a UUID (universally unique identifier).

The identifier information may be the portion of the data stream 103 itself. The identifier information in the return data signal 104 may include the portion of the data stream 103 as it was in the data stream 103 (i.e., identical to the portion of the data stream 103) except that the identifier information may be an encrypted form of (the information contained in) the portion of the data stream 103. The identifier information may be based on information or values or codes included in the portion of the data stream 103.

The identifier information, being based on the portion of the data stream 103, may act as an indication to the processing module 102 or the (requesting) device 100 that the return data signal 104 is for information feedback from the target unit rather than a command (or instruction) to the device 100.

The return data signal 104 may be another (new) data stream generated by the target unit, or may be the data stream 103 broadcast by the transmitting module 101 of the device 100 but modified to include the information corresponding to the request.

In the context of various embodiments, the term “broadcast” may mean relaying of data stream or data signal from one device directly to another device, without having to pass through an intermediate element or device (e.g., a network node, a server, a gateway, etc.). The term “broadcast” may further mean relaying of data stream or data signal from one device directly to another device, without the requirement for “pairing” of both devices to each other in order to allow a communication exchange (e.g., exchange of information) between both devices, as required in “classical” Bluetooth protocol. Such “pairing” may limit both devices to a one-to-one connection such that during the communication exchange between both devices, a third device is unable to initiate or conduct another communication exchange with either of both devices. In contrast, for broadcast between two devices, each device may be available for communication with a plurality of devices, for example, one-to-many, many-to-one, and many-to-many communications. Further, it should be appreciated that in a “broadcast” communication between two devices, the communication may be bi-directional, but no connection or pairing between the two devices may be necessary or required for a communication exchange.

In the context of various embodiments, the information corresponding to the request may be provided or located at another portion of the return data signal 104 as compared to the portion of the return data signal 104 containing the identifier information. This may mean that respective portions or parts of the return data signal 104 containing the identifier information and the information corresponding to the request may be non-overlapping. As a non-limiting example, the respective portions may be (immediately) adjacent to each other.

In the context of various embodiments, the return data signal 104 may be Bluetooth-compliant (e.g., BLE-compliant, e.g., having an iBeacon profile) and the information corresponding to the request may be provided or located in at least one of a Major portion or a Minor portion of the return data signal 104.

The data stream 103 may be broadcast as part of an ad-hoc communication with the target unit. In this way, the transmitting module 101 may be configured to broadcast the data stream 103 to the target unit on an ad-hoc basis. This may mean that the device 100 may request information from the target unit via discrete ad-hoc broadcast of one or more data streams.

It should be appreciated that the transmitting module 101 and the processing module 102 may be separate modules, or may be comprised in one module or unit. In various embodiments, the transmitting module 101 and the processing module 102 may form part of or included in a processor (or processing unit), or the device 100 may include a processor (or processing unit) configured to perform the functions described for the transmitting module 101 and the processing module 102.

In the context of various embodiments, any one of the terms “data stream” or “data signal” may mean a data packet, a broadcast data, a broadcast (data) stream, or a broadcast (data) signal.

In the context of various embodiments, the term “unit” in the context of “target unit” may be used interchangeably with any of the following: device, apparatus, article, object, item, or the like, and the term “unit” is used to distinguish the target unit from the (requesting) device that requests for information from the target unit.

In various embodiments, as non-limiting examples, the request may be a status request, for example, of the target unit, e.g., relating to the state or mode of operation, the battery life, etc., and/or the information requested may relate to one or more parameters relating to the environment or ambient condition(s), e.g., temperature.

In various embodiments, the processing module 102 may be configured to generate the data stream 103 for broadcast. The processing module 102 may include a generating module for generating the data stream 103.

In various embodiments, the transmitting module 101 may be configured to broadcast the data stream 103 further including an identifying information associated with the target unit. This may mean that the data stream 103 broadcast by or from the transmitting module 101 or the device 100 may include the request for the target unit and the identifying information associated with the target unit. The identifying information associated with the target unit may act as an identification or verification to the target unit that the data stream 103 is intended for the target unit. The identifying information may be uniquely associated with the target unit. The identifying information may be the device ID of the target unit.

In the context of various embodiments, the identifying information (uniquely) associated with the target unit may be defined as a header of the data stream or may be placed in a header section of the data stream.

In the context of various embodiments, different respective identifying information may be (uniquely) associated with respective target units. As a non-limiting example, a first data stream including a request for a first target unit may include a first identifying information associated with the first target unit, while a second data stream including a request for a second target unit may include a second identifying information associated with the second target unit, where the first and second identifying information are different to one another, e.g., in terms of the identifying value.

The transmitting module 101 may be further configured to encrypt the data stream 103 prior to broadcasting the data stream 103. This may mean that the data stream 103 as received by the target unit may be in an encrypted form.

In the context of various embodiments, where a data stream or data signal may be transmitted and/or received in an encrypted form, it should be appreciated that the transmitting device and the receiving device may be provided with a compatible or matching method or algorithm suitable for the encryption and the decryption so that the encrypted data stream (or signal) may be appropriately decrypted to yield intelligible information.

In the context of various embodiments, it should be appreciated that a reference to a “transmitter” or a “transmitting device” may include a reference to a “broadcasting device”.

In various embodiments, the processing module 102 may be further configured to filter, based on the identifier information, the return data signal 104 from data signals available. This may mean that from a plurality of data signals that may be available or present on air, the processing module 102 may employ the identifier information as a filtering parameter for capturing the return data signal 104 for retrieval for the information corresponding to the request. For example, the portion of the data stream 103 may be used or defined as the filtering parameter or value such that a data signal having an identifier information based on the portion of the data stream 103 may be filtered and captured by the processing module 102 or the device 100 (and which may be subsequently processed), while other data signals not fulfilling the criteria of the filtering parameter may not be captured and/or processed by the device 100.

Filtering may be carried out prior to the processing module 100 retrieving the information. As a non-limiting example, after the data stream 103 with the request has been broadcast, the device 100 may switch to a scanning mode to scan for data signals over the air which may be available to the device 100, and filter, from among these data signals, the data signal (e.g., return data signal 104) containing the identifier information for processing by the processing module 102 to retrieve the information corresponding to the request.

The processing module 102 may be further configured to decrypt, in response to the identifier information being in an encrypted form, the return data signal 104. For example, the identifier information may be an encrypted form of the portion of the data stream 103. After decryption, the identifier information may be the portion of the data stream as it was broadcast.

In various embodiments, the device 100 or the transmitting module 101 may be further configured to broadcast a second data stream including an instruction to the target unit for controlling the target unit. The second data stream may be broadcast in a radio frequency range. The second data stream may further include an identifying information for verification by the target unit.

In various embodiments, the device 100 may be configured to be in an RF (radio frequency) silent mode (or state or condition) prior to broadcasting of the data stream 103. The device 100 may also be configured to be in an RF silent mode prior to broadcasting of the second data stream. In various embodiments, the device 100 may be configured to be in an RF silent mode, other than when broadcasting a data stream (e.g., the data stream 103 and/or the second data stream).

In the context of various embodiments, a device in an “RF silent mode” means that the device, while powered on, is in a non-broadcasting or non-transmitting mode (or state or condition) for an RF signal. In other words, the device may be in an RF silent mode of operation where there is no broadcast of any RF signal. For example, prior to the data stream 103 being broadcast, the device 100 may not broadcast or transmit any RF signal. As a non-limiting example, the device 100, when powered on, may broadcast RF signals or data streams on an intermittent basis (e.g., on demand or ad-hoc basis) as compared to known devices which continuously send out RF signals once powered on. For example, device 100 may maintain RF silence when there is no request for information or instruction to be broadcast from the device 100 to the target unit. This may mean that the device 100 may be configured to be in an RF silent mode, other than when broadcasting the data stream 103 or when communicating with the target unit. There is no network connection between the device 100 and the target unit, and requests or instructions may be sent to the target unit as and when required. In this way, in various embodiments, RF silence may be maintained between or among all devices/units when no instruction or data stream is being broadcast or sent out. In this way, communication between the device 100 and target unit may be ad-hoc. As such, by maintaining RF silence, the request for information or control from the device 100 to the target unit may be on an ad-hoc basis. Further, by maintaining RF silence, the presence of RF controllable devices may not be made known to any person. In other words, anyone may be prevented from knowing that there may be RF controllable devices in the environment or ecosystem.

In various embodiments, the transmitting module 101 may be further configured to broadcast the data stream 103 to a plurality of target units simultaneously, and/or the processing module 102 may be further configured to receive or process (e.g., to retrieve information corresponding to the request), simultaneously, a plurality of return data signals broadcast by a plurality of target units.

In the context of various embodiments, the transmitting module 101 may be configured to broadcast the data stream 103 in compliance with a Bluetooth protocol (e.g., Bluetooth Low Energy; BLE) or a Wi-Fi protocol (e.g., Wi-Fi headless). As a non-limiting example, the data stream 103 may be Bluetooth-compliant. This may mean that the data stream 103 may have a structure or profile that may be Bluetooth-compliant, or in accordance with Bluetooth protocol. As a non-limiting example, the data stream 103 may be BLE-compliant or having a BLE data structure, for example, having an iBeacon profile.

FIG. 1B shows a schematic diagram for a device 106 for supplying information to a requesting unit, according to various embodiments. The device 106 includes a processing module 107 configured to broadcast, in response to a request included in a data stream (represented by arrow 108) received from the requesting unit, a return data signal (represented by arrow 109) including an identifier information based on at least a portion of the data stream 108, and information corresponding to the request.

In other words, a device 106 for supplying information to a requesting unit may be provided. Accordingly, the device 106 may be a supplying device capable of providing information. The device 106 may be used as part of a command and control system or communication. In various embodiments, the device 106 may be a communication device, for example, a phone (e.g., a smartphone), a tablet (computer), an (smart) electrical device or appliance, a sensor, etc. In the context of various embodiments, the requesting unit may be the device as described herein for requesting information.

The processing module 107 may be configured to broadcast (e.g., wirelessly or via wireless communication), in response to a request (for information) included in a data stream 108 received from the requesting unit, a return data signal 109 having therein an identifier information based on at least a portion of the data stream 108, and the information corresponding to the request (for the requesting unit, to be received and processed by the requesting unit). The return data signal 109 may be broadcast as part of an ad-hoc communication with the requesting unit. In this way, the processing module 107 may be configured to broadcast the return data signal 109 to the requesting unit on an ad-hoc basis. This may mean that the device 106 may supply the information to the requesting unit via discrete ad-hoc broadcast of one or more return data signals.

The processing module 107 may be capable of broadcasting the return data signal 109 or may include a transmitting module configured to broadcast the return data signal 109.

In the context of various embodiments, the term “unit” in the context of “requesting unit” may be used interchangeably with any of the following: device, apparatus, article, object, item, or the like, and the term “unit” is used to distinguish the requesting unit from the (supplying) device that supplies the information requested by the requesting unit.

In various embodiments, the processing module 107 may be configured to generate the return data signal 109 for broadcast. The processing module 107 may include a generating module for generating the return data signal 109.

In various embodiments, prior to broadcasting the return data signal 109, the processing module 107 may be further configured to verify an identifying information included in the data stream 108 to be associated with the device 106. The identifying information may be uniquely associated with the device 106. The identifying information may be the device ID of the device 106.

The processing module 107 may be further configured to decrypt, in response to the data stream 108 received being in an encrypted form, the data stream 108.

The processing module 107 may be further configured to encrypt the return data signal 109. This may mean that the identifier information may be in an encrypted form for broadcasting of the return data signal 109. For example, the identifier information may be an encrypted form of the portion of the data stream 108.

In the context of various embodiments, the processing module 107 may be further configured, prior to broadcast, to define a leading portion (or front portion, for example, first few bytes, e.g., first 16 Bytes) of the data stream 108 as the portion of the data stream 108, and further configured to provide the identifier information based on the leading portion.

In the context of various embodiments, the processing module 107 may be further configured to provide the identifier information in a first portion of the return data signal 109, and the information corresponding to the request in a second portion of the return data signal 109. The first and second portions may be different portions of the return data signal 109. The first and second portions may be non-overlapping. For example, the first and second portions may be (immediately) adjacent to each other. As a non-limiting example, the return data signal 109 may be Bluetooth-compliant (e.g., BLE-compliant, e.g., having an iBeacon profile) and the second portion may include at least one of a Major portion or a Minor portion of the return data signal 109.

In various embodiments, the device 106 may be configured to be in an RF (radio frequency) silent mode (or state or condition) prior to broadcasting of the return data signal 109. In various embodiments, the device 106 may be configured to be in an RF silent mode, other than when broadcasting a return data signal (e.g., the return data signal 109).

In various embodiments, the processing module 107 may be further configured to receive a plurality of data streams simultaneously from a plurality of requesting units and/or broadcast the return data signal 109 to a plurality of requesting units simultaneously.

In the context of various embodiments, the processing module 107 may be configured to broadcast the return data signal 109 in compliance with a Bluetooth protocol (e.g., Bluetooth Low Energy; BLE) or a Wi-Fi protocol (e.g., Wi-Fi headless). As a non-limiting example, the return data signal 109 may be Bluetooth-compliant. This may mean that the return data signal 109 may have a structure or profile that may be Bluetooth-compliant, or in accordance with Bluetooth protocol. As a non-limiting example, the return data signal 109 may be BLE-compliant or having a BLE data structure, for example, having an iBeacon profile.

In various embodiments, the device 106 or the processing module 107 may be further configured to assess an identifying information included in a second data stream (e.g., broadcast by the requesting unit) received for verification of the second data stream to be intended for the device 106, and further configured, in response to the verification, to execute an instruction included in the second data stream to operate the device 106.

FIG. 1C shows a schematic diagram for a device 115, according to various embodiments. The device 115 includes a transmitting module 116, and a processing module 117. The transmitting module 116 and the processing module 117 may be coupled to one another (represented by the line 118), for example, physically coupled and/or electrically coupled. In a first mode of operation of the device 115, the transmitting module 116 is configured to broadcast a data stream including a request for a target unit, and the processing module 117 is configured to retrieve, from a return data signal by the target unit including an identifier information based on at least a portion of the data stream, information corresponding to the request. In a second mode of operation of the device 115, the processing module 117 is configured, in response to a request included in a data stream received from a requesting unit, to broadcast a return data signal including an identifier information based on at least a portion of the data stream, and information corresponding to the request.

FIG. 1D shows a schematic diagram for a device 110a, 110b, 110c according to various embodiments. The device may include a processor 111a, 111b, 111c and a memory 112a, 112b, 112c coupled to the processor 111a, 111b, 111c (represented by the line 113a, 113b, 113c), for example, physically coupled and/or electrically coupled.

In various embodiments, for a device 110a for requesting information from a target unit, the device 110a includes a processor 111a and a memory 112a having stored therein instructions, which when executed by the processor 111a, cause the processor 111a to broadcast a data stream including a request for the target unit, and retrieve, from a return data signal by the target unit including an identifier information based on at least a portion of the data stream, information corresponding to the request.

In various embodiments, for a device 110b for supplying information to a requesting unit, the device 110b includes a processor 111b and a memory 112b having stored therein instructions, which when executed by the processor 111b, cause the processor 111b to broadcast, in response to a request comprised in a data stream received from the requesting unit, a return data signal including an identifier information based on at least a portion of the data stream, and the information corresponding to the request.

In various embodiments, for a device 110c, the device 110c includes a processor 111c and a memory 112c having stored therein instructions, which when executed by the processor 111c, cause the processor 111c, in a first mode of operation of the device, to broadcast a data stream including a request for the target unit, and to retrieve, from a return data signal by the target unit including an identifier information based on at least a portion of the data stream, information corresponding to the request, and, in a second mode of operation of the device, to broadcast, in response to a request included in a data stream received from a requesting unit, a return data signal including an identifier information based on at least a portion of the data stream, and information corresponding to the request.

Various embodiments may also provide a system or arrangement including a (first) device as described herein for requesting information from a target (receiving) unit and a (second) device as described herein for supplying information to a requesting unit.

FIG. 1E shows a flow chart 120 illustrating a method for requesting information from a target unit, according to various embodiments.

At 121, a data stream including a request for the target unit is broadcast.

At 122, from a return data signal by the target unit including an identifier information based on at least a portion of the data stream, information corresponding to the request is retrieved.

In various embodiments, at 121, the data stream that is broadcast may further include an identifying information associated with the target unit. The identifying information may be uniquely associated with the target unit. The identifying information may be the device ID of the target unit.

The data stream may be encrypted prior to the data stream being broadcast.

The return data signal may be filtered, based on the identifier information, from data signals available.

In response to the identifier information being in an encrypted form, the return data signal may be decrypted.

In various embodiments, the method may be RF silent prior to broadcasting the data stream at 121.

In various embodiments, at 121, the data stream may be broadcast in compliance with a Bluetooth protocol (e.g., Bluetooth Low Energy; BLE) or a Wi-Fi protocol (e.g., Wi-Fi headless).

FIG. 1F shows a method 123 for supplying information to a requesting unit, according to various embodiments. At 124, in response to a request for information included in a data stream received from the requesting unit, a return data signal including an identifier information based on at least a portion of the data stream, and the information corresponding to the request, is broadcast.

Prior to the return data signal being broadcast, an identifying information included in the data stream may be verified to be (uniquely) associated with a device performing the method.

In response to the data stream received being in an encrypted form, the data stream may be decrypted.

The return data signal may be encrypted.

Prior to the return data signal being broadcast, a leading portion of the data stream may be defined as the portion of the data stream, and the identifier information may be provided based on the leading portion.

The identifier information may be provided in a first portion of the return data signal, and the information corresponding to the request may be provided in a second portion of the return data signal.

In various embodiments, the method 123 may be RF silent prior to broadcasting the return data signal at 124.

In various embodiments, at 124, the return data signal may be broadcast in compliance with a Bluetooth protocol (e.g., Bluetooth Low Energy; BLE) or a Wi-Fi protocol (e.g., Wi-Fi headless).

FIG. 1G shows a flow chart 125 illustrating a method for a device, according to various embodiments.

At 126, in a first mode of operation of the device, a data stream including a request for a target unit is broadcast, and, from a return data signal by the target unit including an identifier information based on at least a portion of the data stream, information corresponding to the request is retrieved.

At 127, in a second mode of operation of the device, in response to a request for information included in a data stream received from a requesting unit, a return data signal including an identifier information based on at least a portion of the data stream, and the information corresponding to the request, is broadcast.

Various embodiments may also provide a method including a (first) method as described herein for requesting information from a target unit and a (second) method as described herein for supplying information to a requesting unit.

While the methods described above are illustrated and described as a series of steps or events, it will be appreciated that any ordering of such steps or events are not to be interpreted in a limiting sense. For example, some steps may occur in different orders and/or concurrently with other steps or events apart from those illustrated and/or described herein. In addition, not all illustrated steps may be required to implement one or more aspects or embodiments described herein. Also, one or more of the steps depicted herein may be carried out in one or more separate acts and/or phases.

FIG. 1H shows a schematic diagram for an application (“App” or “app”) 128a, 128b, 128c, according to various embodiments. The application 128a, 128b, 128c (e.g., mobile app) is adapted to be installed on a device (for example, a mobile device, a smart device (e.g., a smart mobile device) or a wireless communication device).

In various embodiments, the application 128a includes processor-executable instructions for execution on the device to carry out a method as described herein for requesting information from a target unit.

In various embodiments, the application 128b includes processor-executable instructions for execution on the device to carry out a method as described herein for supplying information to a requesting unit.

In various embodiments, the application 128c includes processor-executable instructions for execution on the device, to carry out, in a first mode of operation, a method as described herein for requesting information from a target unit, and, to carry out, in a second mode of operation, a method as described herein for supplying information to a requesting unit.

FIG. 1I shows a schematic diagram for a computer program or a computer program product 129a, 129b, 129c, according to various embodiments.

In various embodiments, the computer program or the computer program product 129a includes instructions which, when executed by a computing device, cause the computing device to carry out a method as described herein for requesting information from a target unit.

In various embodiments, the computer program or the computer program product 129b includes instructions which, when executed by a computing device, cause the computing device to carry out a method as described herein for supplying information to a requesting unit.

In various embodiments, the computer program or the computer program product 129c includes instructions which, when executed by a computing device, cause the computing device, in a first mode of operation, a method as described herein for requesting information from a target unit, and, to carry out, in a second mode of operation, a method as described herein for supplying information to a requesting unit.

In the context of various embodiments, the computer program product 129a, 129b, 129c may be or may include a computer-readable storage medium.

In the context of various embodiments, the term “verify” and any variation of the word (e.g., verification) may mean validation or authentication.

In the context of various embodiments, the data stream as described herein and/or the return data signal as described herein may be broadcast in the RF (radio frequency) range, meaning an RF signal. The frequency for the data stream and/or the return data signal, as an RF signal, may be dependent on the device broadcasting the signal, for example, the 2.4 GHz ISM (industrial, scientific and medical) band for smartphones. In various embodiments, the RF signal broadcast may be between about 2.4 GHz and about 2.4835 GHz, corresponding to the 2.4 GHz ISM band, or at 5 GHz.

In the context of various embodiments, communication between devices or units described herein may be within a range extending up to between 10 meters and 100 meters, depending on the signal strength. It should be appreciated that communication between devices within 10 meters or less of each other is possible.

It should be appreciated that descriptions in the context of any one of the devices, the systems, the methods, the applications, the computer programs and the computer program products described herein may correspondingly be applicable in relation to any one of the others described herein.

Various embodiments may also provide a device for broadcasting a data stream to a receiving unit, the device including a generating module configured to generate a header for the data stream based on an identifier (or identifying information) associated with the receiving unit, and a processing module configured to broadcast the data stream including the header. The identifier may be uniquely associated with the receiving unit.

Various embodiments may also provide a device for receiving a data stream from a transmitting unit, the device including a generating module configured to generate a filtering parameter based on an identifier (or identifying information) associated with the device, and a processing module configured, in response to a data stream received from the transmitting unit including a header matching the filtering parameter, to process the data stream. The identifier may be uniquely associated with the receiving unit.

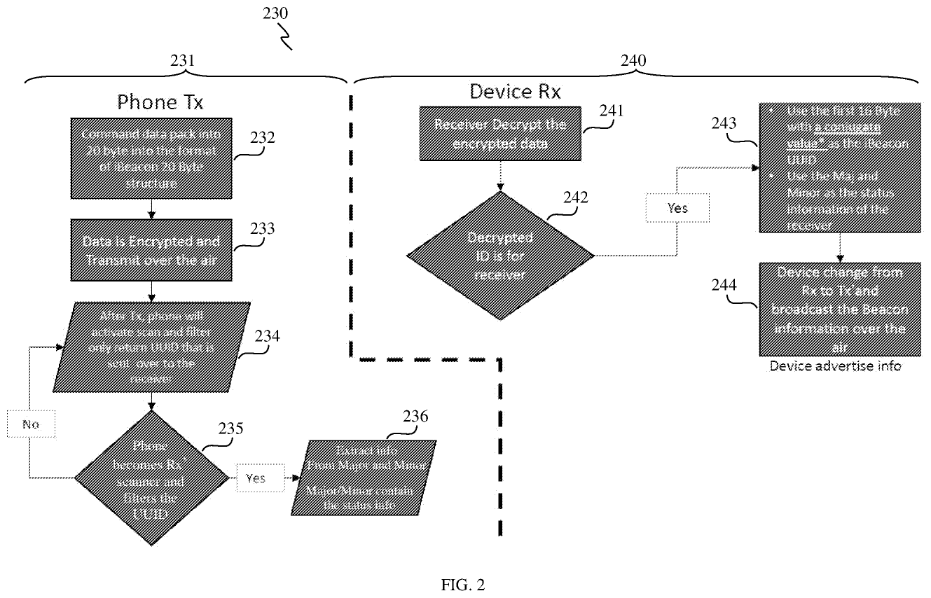

FIG. 2 shows a schematic diagram 230 illustrating flow charts 231, 240 for a method for information feedback (e.g., a status feedback), according to various embodiments. The flowchart 231 relates to the side of the transmitting device (e.g., a smartphone or a gateway) (Tx), while the flowchart 240 relates to the side of the receiving device (Rx).

Referring to the flowchart 231 for a transmitting device (Tx) (or requesting device), at 232, a command data pack (or stream or package or signal) may be provided or formed into 20 bytes, for example, in the format of iBeacon 20 Byte structure. At 233, the data package may be encrypted and then broadcast (or transmitted) over the air. At 234, after the broadcast, the Tx may activate a scanning process and a filtering process for a (specific or predetermined) return UUID, where the return UUID may be defined based on a portion of the data package broadcast to the target receiving device (Rx).

At 235, the Tx becomes or changes to a receiving scanner (effectively becoming a receiving device, Rx′) and filters the UUID of one or more signals broadcast over the air to identify any signal that may be broadcast by the original target Rx, in return. If it is determined that the UUID of a signal broadcast over the air does not correspond to the UUID filter of the Rx′, the Rx′ repeats the scanning process for signals at 234. If it is determined that the UUID of a signal broadcast over the air, for example, a return UUID (e.g., in the form UUID* (or encrypted UUID)) of a (corresponding) return data package (or signal) corresponds to the UUID filter of the Rx′, the Rx′ may then, at 236, process the return data package, and extract the information provided in response to the request. Such information may be provided in at least one of the Major portion or Minor portion of the return data package. The return data package received may first be decrypted by the Rx′ where such data package has been encrypted prior to transmission or broadcast.

Referring to the flowchart 240 for a receiving device (Rx) (or supplying device), at 241, the Rx may receive the data package broadcast from the Tx as described above, and may proceed to decrypt the encrypted data package. If, at 242, it is determined that the ID decrypted from data package corresponds to the Rx, the Rx may then proceed to process the received data package, including performing the process at 243 in response to a request including in the data package that is received. If it is determined that the ID decrypted from data package does not correspond to the Rx, no further processing of the data package is carried out.

At 243, a portion of the data package received, for example, the first 16 Bytes of the data package, may be used to define the UUID of a signal or data package (e.g., an iBeacon UUID) to be broadcast by the Rx in response to the data package or request received from the Tx. A conjugate value may also be used to define the UUID. The conjugate value (or encryption parameter or value) is used to encrypt the true data that is intended to be the UUID for the data package to be broadcast by the Rx, for example, for information or status feedback. The conjugate value may provide for UUID=f(DID, TimeTag), where “f” represents “a function of”. The information in response to the request made, for example, information relating to the Rx (e.g., relating to a status of the Rx) may be included in a portion of the data package, other than the portion defining the UUID, to be broadcast by the Rx. The information may be included in at least one of a Major or Minor portion of the data package.

At 244, the Rx changes to being a transmitter (effectively becoming a transmitting device, Tx′) to broadcast the data package with the UUID and the information relating to the request made over the air, for receipt by the originating Tx which made the request.

The information receiving device (being the originating Tx or effectively Rx′), which may be a phone or another gateway, may receive and use the UUID filter as an indication that the data package received from the information transmitting device (being the Rx or effectively Tx′) relates to an information or status feedback and not a command.

Accordingly, in various embodiments, a Tx may send or broadcast a data package including an ID corresponding to a target Rx and a request for information over the air, to be received by a target Rx. A portion of the data package may define UUID information. The target Rx may receive and process the data package. In response to the request, the Rx may then change to a transmitter, Tx′, to broadcast a return data package including a return UUID (e.g., UUID*) based on or corresponding to the UUID defined using a portion of the data package transmitted by the originating Tx and the information relating to the request over the air, to be received by the originating Tx which has now changed to a receiver, Rx′. Accordingly, it should be appreciated that UUID* may be an encrypted version of UUID, or put in another way, the UUID may be encrypted (via the conjugate value) to form UUID*. The UUID may be combined or modified or manipulated with the conjugate value to generate UUID*.

As a non-limiting example, the sender (Tx) may send a status request to the specific receiver through the Unique Device ID. When the specific device (receiver) receives the request (e.g., status request), the receiver may then send the feedback using the UUID information as the identifying filter for the sender, and inserting the feedback data into the Major and Minor portions of the BLE data structure, where the receiver switches to a transmitting mode to broadcast the return feedback or signal. After the sender sends out the data request (or status request), the sender switches to a receiver mode and scan for the pre-determined UUID information that it has previously sent out to the target device (receiver). When the sender scans and finds UUID information that matches the pre-determined UUID, it may extract both the Major and Minor information and collate it with the information data structure. By having a predetermined UUID feeding back to the sender or requesting device (e.g., a mobile device), the requesting device may use a UUID filter to “snift out” the data (e.g., return data signal) in the air and may quickly pull the information found on the Major and Minor portions. By not having a quick (UUID) filter, the requesting device may need to decrypt all data present in the air to determine the correct information that it is seeking from the receiver device (or supplying device).

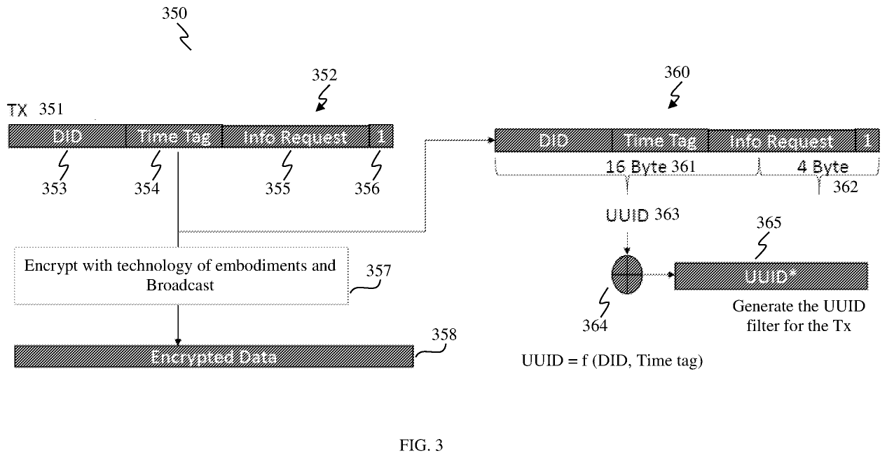

FIG. 3 shows a schematic diagram 350 illustrating a method for information feedback (e.g., status feedback), according to various embodiments. A transmitting device or requesting device (e.g., a smartphone), Tx, 351 may provide or generate a data package 352 including a portion 353 containing a device ID (DID) corresponding to a target (receiving) device, a portion 354 containing time tag (or timing information), a portion 355 containing request for information, and a portion 356 containing an indicator representing a mode of operation for the target device (e.g., to act as a receiving device or a broadcasting device). For example, when the indicator in the portion 356 is set as “0” (e.g., in the form of code “00”), the target device may operate as a receiving device to act upon the data or instruction encrypted in the data stream received and to output the result to an output port of the target device. It should be appreciated that, when the transmitting device sends out instruction or information to the target device, the encrypted data has the necessary information for the output port of the target device when the portion 356 is set to “0”.

When the indicator in the portion 356 is set as “1” (e.g., in the form of code “FF”), the target device may operate as a broadcasting device to broadcast (i.e., to feedback) information (as part of a return data signal) corresponding to a request contained in a data stream broadcast by and received from a requesting device. As a further non-limiting example, the portion 356 may contain a value “1” representing a command to the target device to feedback the status the target device is currently in.

At 357, the data package 352 may be encrypted and broadcast, such that the encrypted data 358 may be broadcast over the air to be received by the target device.

As illustrated in FIG. 3, as a non-limiting example, the data package 352 may include a string of 20 Bytes (e.g., a 20-Byte data package) 360. For the data package 360, a portion thereof, for example the first 16 Bytes 361 may be used to define a UUID (universally unique identifier) 363. The first 16 Bytes 361 may be comprised in the portions 353, 354, and part of the portion 355. The remaining 4 Bytes 362 of the data package 360 may be comprised in the portion 356 and the remaining part of the portion 355. The UUID 363 may be combined or modified or manipulated with a conjugate value 364 to form UUID* 365 (for example, formed at the target receiving device). The conjugate value (or encryption parameter or value) 364 is used to encrypt the UUID information.

The Tx 351 may then switch to a receiver mode, turn on scanning and filter for UUID*. When the device 351, in the receiver mode, receives UUID* (as part of a data package) from the air, the device captures the signal and processes the Major and Minor portions of the data package received according to the type of request for information that it had sent out.

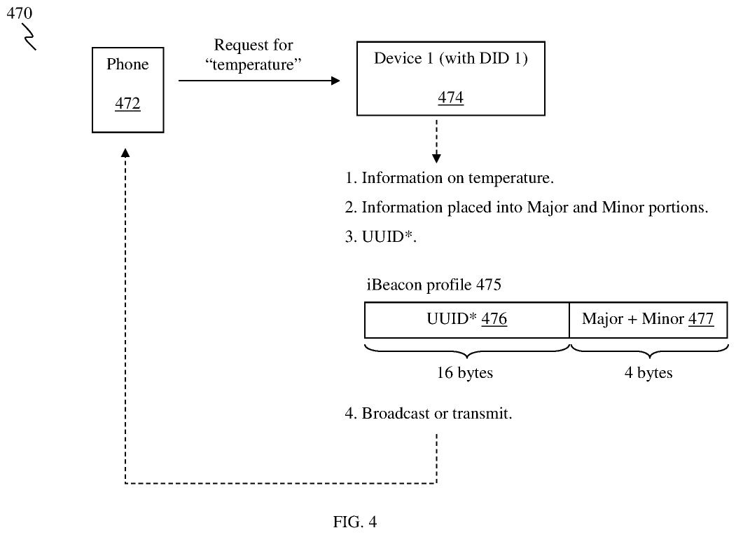

FIG. 4 shows a schematic diagram 470 illustrating a method for information feedback, depicting a non-limiting example of making a request for information relating to temperature. A phone 472, acting as a transmitting (or requesting) device, may send a request for temperature information to a target receiving device, for example, Device 1 (having a corresponding DID 1) 474. As examples, the request may relate to the internal temperature of Device 1 474 (e.g., when it is in operation to perform a task, e.g., lighting) or an external or ambient temperature (e.g., where Device 1 474 is a temperature sensor). The information relating to the temperature may be placed in the Major and Minor portions 477 of an iBeacon profile 475, and a UUID* 476 may be generated to form part of the iBeacon profile 475. The iBeacon profile 475 may then be broadcast by Device 1 474 over the air, intended for and to be received by the requesting device, this being the phone 472.

Generally, in order to prevent the receiver or receiving device (Rx) from decrypting every signal over the air, a header in the broadcast system is inserted. In this way, the header may act as an identifier to denote to the Rx that the associated signal is intended for the Rx. Using the header, the Rx is able to do a first pass filter to extract only the specific data on the air and perform a decryption. One challenge may be that there may be many receivers in a small area and there are a lot of broadcast signals from multiple transmitting devices. In this condition, a receiver may be overwhelmed by the different signals in the air, and in trying to determine which signal is for the receiver. Hence, it may cause the receiver to be overloaded, which may result in DoS (Denial of services). Thus, to prevent this scenario, it is preferable that the header for each signal being sent to the Rx is different.

In view of the above, various embodiments may further provide a dynamic header identifier for a receiver or receiving device (Rx). As a non-limiting example, the header for each signal being sent to (and intended for) a particular Rx may be different for signal(s) intended for another (different) receiving device (e.g., Rx”).

In order to have the header for one or more signals for each receiver to be different, various embodiments use the receiving device ID (identifier) to generate the header needed for the receiver filter.

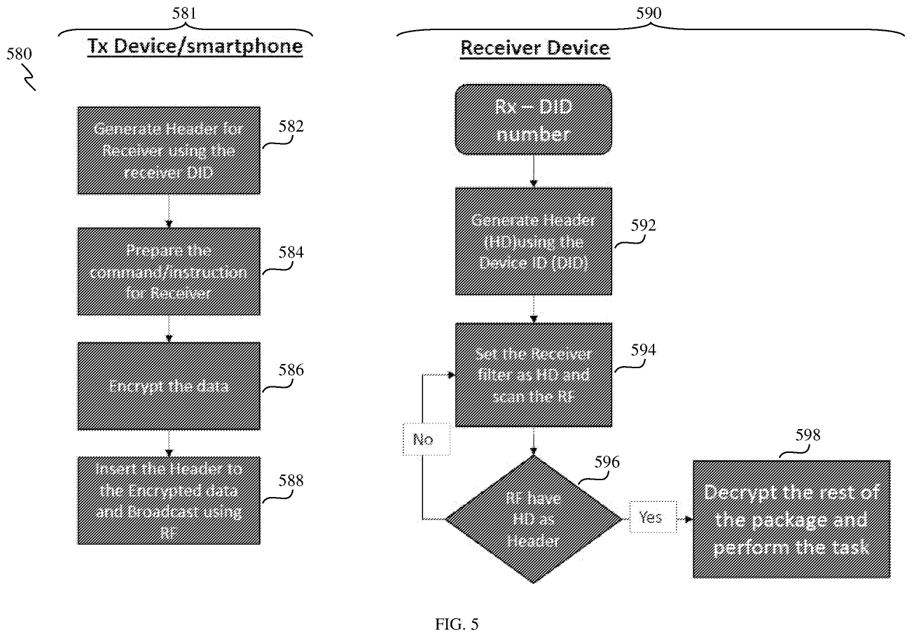

FIG. 5 shows a schematic diagram 580 illustrating flow charts 581, 590 for a method for generating a header, according to various embodiments. The flowchart 581 relates to the side of the transmitting device (e.g., a smartphone) (Tx), while the flowchart 590 relates to the side of the receiving device (Rx).

Referring to the flowchart 581 for a transmitting device (Tx), at 582, the Tx may generate a header for a signal (or data stream) for a (predetermined or intended or target) receiving device using the ID of the receiving device (DID). In various embodiments, each DID and/or header may be one or more numbers, or a set/sequence of numbers. As the header for a signal for a target Rx is based on the (unique) DID of that target Rx, the respective header broadcast or transmitted with the associated respective signal is not a fixed number for different signals intended for different receivers, but rather random numbers, relative to each other, broadcast or transmitted over the air. Such randomisation of the header is determined by the ID of the receiving device. This may mean that a (one) transmitter or transmitting device (Tx) may send data or signals with different headers for the corresponding different receiving devices, based on the ID of the respective Rx.

Different devices may have fixed different DIDs, e.g., DID 1 may be “88”, DID 2 may be “89”, and hence, the headers of signals for different receiving devices may be different as a result of the different DIDs of the receiving devices. The header for a signal intended for a target Rx may be fixed, to be associated with the DID of the target Rx. In known methods, signals that are transmitted, even if intended for different receiving devices, may have the same header.

At 584, the command/instruction (or in some embodiments, a request for information) for the target Rx may be prepared, e.g., in the form of a data signal (or stream or package). At 586, the data may be encrypted.

At 588, the header that has been generated may be inserted into the encrypted data and then broadcast using RF (radio frequency).

Referring to the flowchart 590 for a receiving device (Rx), the Rx has an associated DID number. At 592, a header (e.g., labelled as “HD”) may be generated using the DID. At 594, the filter for the RX may be set as HD and the Rx may then scan the RF signals broadcast through the air. In various embodiments, when the DID is programmed into the Rx or an associated module, the internal firmware of the Rx or module may automatically generate the header (“HD”) and use it as the RF filter.

At 596, the Rx may check whether a signal includes HD as its header. If it is determined that the header of the signal is not identical to HD, the Rx repeats the scanning process for signals at 594. If it is determined that the header of the signal is identical to HD, the Rx may then, at 598, decrypt the signal or the rest of the data package, and carry out the task (e.g., to execute an instruction or to provide information corresponding to a request) provided with the data package. Therefore, for a signal intended for the target Rx, the signal includes HD as its header. Accordingly, it should be appreciated that the header generated by a Tx for a signal intended for a target Rx, using the DID of the target, and the header generated by the Rx using its DID, to be used as the Rx filter, are identical. This may mean that similar or like processes or algorithm may be employed to generate the headers at both the Tx and Rx sides, based on the DID of the Rx.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A device for requesting information from a target unit, the device comprising:
a transmitting module configured to broadcast a data stream comprising a request for the target unit; and
a processing module configured to retrieve, from a return data signal by the target unit comprising an identifier information based on at least a portion of the data stream, information corresponding to the request.

2. The device as claimed in claim 1, wherein the transmitting module is configured to broadcast the data stream further comprising an identifying information associated with the target unit.

3. The device as claimed in claim 1 or 2, wherein the transmitting module is further configured to encrypt the data stream prior to broadcasting the data stream.

4. The device as claimed in any one of claims 1 to 3, wherein the processing module is further configured to filter, based on the identifier information, the return data signal from data signals available.

5. The device as claimed in any one of claims 1 to 4, wherein the device is configured to be in an RF silent mode prior to broadcasting of the data stream.

6. The device as claimed in any one of claims 1 to 5, wherein the transmitting module is configured to broadcast the data stream in compliance with a Bluetooth protocol or a Wi-Fi protocol.

7. A device for requesting information from a target unit, the device comprising:
a processor; and
a memory coupled to the processor, the memory having stored therein instructions, which when executed by the processor, cause the processor to:
broadcast a data stream comprising a request for the target unit; and
retrieve, from a return data signal by the target unit comprising an identifier information based on at least a portion of the data stream, information corresponding to the request.

8. A device for supplying information to a requesting unit, the device comprising:
a processing module configured to broadcast, in response to a request comprised in a data stream received from the requesting unit, a return data signal comprising an identifier information based on at least a portion of the data stream, and information corresponding to the request.

9. The device as claimed in claim 8, wherein, prior to broadcasting the return data signal, the processing module is further configured to verify an identifying information comprised in the data stream to be associated with the device.

10. The device as claimed in claim 8 or 9, wherein the processing module is further configured to encrypt the return data signal.

11. The device as claimed in any one of claims 8 to 10, wherein the processing module is further configured, prior to broadcast, to define a leading portion of the data stream as the portion of the data stream, and further configured to provide the identifier information based on the leading portion.

12. The device as claimed in any one of claims 8 to 11, wherein the processing module is further configured to provide the identifier information in a first portion of the return data signal, and the information corresponding to the request in a second portion of the return data signal.

13. The device as claimed in any one of claims 8 to 12, wherein the device is configured to be in an RF silent mode prior to broadcasting of the return data signal.

14. The device as claimed in any one of claims 8 to 13, wherein the processing module is configured to broadcast the return data signal in compliance with a Bluetooth protocol or a Wi-Fi protocol.

15. A device for supplying information to a requesting unit, the device comprising:
a processor; and
a memory coupled to the processor, the memory having stored therein instructions, which when executed by the processor, cause the processor to broadcast, in response to a request comprised in a data stream received from the requesting unit, a return data signal comprising an identifier information based on at least a portion of the data stream, and the information corresponding to the request.

16. A device comprising:
a transmitting module; and
a processing module,
wherein, in a first mode of operation of the device, the transmitting module is configured to broadcast a data stream comprising a request for a target unit, and the processing module is configured to retrieve, from a return data signal by the target unit comprising an identifier information based on at least a portion of the data stream, information corresponding to the request, and
wherein, in a second mode of operation of the device, the processing module is configured, in response to a request comprised in a data stream received from a requesting unit, to broadcast a return data signal comprising an identifier information based on at least a portion of the data stream, and information corresponding to the request.

17. A device comprising:
a processor; and
a memory coupled to the processor, the memory having stored therein instructions, which when executed by the processor, cause the processor,
in a first mode of operation of the device, to broadcast a data stream comprising a request for the target unit, and to retrieve, from a return data signal by the target unit comprising an identifier information based on at least a portion of the data stream, information corresponding to the request, and
in a second mode of operation of the device, to broadcast, in response to a request comprised in a data stream received from a requesting unit, a return data signal comprising an identifier information based on at least a portion of the data stream, and information corresponding to the request.

18. A method for requesting information from a target unit, the method comprising:
broadcasting a data stream comprising a request for the target unit; and
retrieving, from a return data signal by the target unit comprising an identifier information based on at least a portion of the data stream, information corresponding to the request.

19. The method as claimed in claim 18, wherein broadcasting a data stream comprises broadcasting the data stream further comprising an identifying information associated with the target unit.

20. The method as claimed in claim 18 or 19, further comprising encrypting the data stream prior to broadcasting the data stream.

21. The method as claimed in any one of claims 18 to 20, further comprising filtering, based on the identifier information, the return data signal from data signals available.

22. The method as claimed in any one of claims 18 to 21, wherein the method is RF silent prior to broadcasting the data stream.

23. The method as claimed in any one of claims 18 to 22, wherein broadcasting a data stream comprises broadcasting the data stream in compliance with a Bluetooth protocol or a Wi-Fi protocol.

24. A method for supplying information to a requesting unit, the method comprising:
broadcasting, in response to a request for information comprised in a data stream received from the requesting unit, a return data signal comprising an identifier information based on at least a portion of the data stream, and the information corresponding to the request.

25. The method as claimed in claim 24, wherein, prior to broadcasting the return data signal, the method further comprising verifying an identifying information comprised in the data stream to be associated with a device performing the method.

26. The method as claimed in claim 24 or 25, further comprising encrypting the return data signal.

27. The method as claimed in any one of claims 24 to 26, further comprising, prior to broadcasting:
defining a leading portion of the data stream as the portion of the data stream; and
providing the identifier information based on the leading portion.

28. The method as claimed in any one of claims 24 to 27, further comprising providing the identifier information in a first portion of the return data signal, and the information corresponding to the request in a second portion of the return data signal.

29. The method as claimed in any one of claims 24 to 28, wherein the method is RF silent prior to broadcasting the return data signal.

30. The method as claimed in any one of claims 24 to 29, wherein broadcasting a return data signal comprises broadcasting the return data signal in compliance with a Bluetooth protocol or a Wi-Fi protocol.

31. A method for a device, the method comprising:
in a first mode of operation of the device, broadcasting a data stream comprising a request for a target unit, and retrieving, from a return data signal by the target unit comprising an identifier information based on at least a portion of the data stream, information corresponding to the request; and
in a second mode of operation of the device, broadcasting, in response to a request for information comprised in a data stream received from a requesting unit, a return data signal comprising an identifier information based on at least a portion of the data stream, and the information corresponding to the request.

32. An application adapted to be installed on a device, the application comprising processor-executable instructions for execution on the device to carry out a method as claimed in any one of 18 to 23.

33. An application adapted to be installed on a device, the application comprising processor-executable instructions for execution on the device to carry out a method as claimed in any one of 24 to 30.

34. An application adapted to be installed on a device, the application comprising processor-executable instructions for execution on the device,
to carry out, in a first mode of operation, a method as claimed in any one of claims 18 to 23; and
to carry out, in a second mode of operation, a method as claimed in any one of claims 24 to 30.

35. A computer program or a computer program product comprising instructions which, when executed by a computing device, cause the computing device to carry out a method as claimed in any one of claims 18 to 23.

36. A computer program or a computer program product comprising instructions which, when executed by a computing device, cause the computing device to carry out a method as claimed in any one of claims 24 to 30.

37. A computer program or a computer program product comprising instructions which, when executed by a computing device, cause the computing device,
to carry out, in a first mode of operation, a method as claimed in any one of claims 18 to 23; and
to carry out, in a second mode of operation, a method as claimed in any one of claims 24 to 30.
